(19) United States
(12) Patent Application Publication
(10) Pub. No.: US 2009/0292568 A1
(43) Pub. Date: Nov. 26, 2009

(54) Adaptive Risk Variables

(76) Inventors: Reza Khosravani, San Diego, CA (US); Maria Derderian, Escondido, CA (US); Gregory Gancarz, San Diego, CA (US); Jenny G. Zhang, San Diego, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/125,858

(22) Filed: May 22, 2008

(51) Int. Cl. G06Q 10/00

(52) U.S. Cl. 705/7

(57) ABSTRACT

Methods, systems and computer-implemented processes for analyzing transactions for fraud are presented. A plurality of risk tables used by a fraud detection model is augmented with temporal change data related to risk variables associated with the plurality of risk tables. The fraud detection model is then executed using the augmented plurality of risk tables to generate a score for transaction data representing a new transaction, the score representing a numerical probability of the existence of fraud based on the fraud detection model.

### BACKGROUND

This disclosure relates generally to fraud detection systems and methods, and more particularly to a system and method for detecting fraud using fraud feedback and adaptive risk variables.

Risk tables are an important part of fraud detection models. Risk tables summarize the statistics (average, standard deviation, etc.) of fraud for specific categories of transactions. For example, risk tables could be calculated for every merchant category code (SIC), country, hour-of-week, zip code, and/or transaction amount range. Historical datasets, typically covering years of data, are then used to estimate the risk (statistics of fraud) for each category. The risk data is stored in several tables.

When a new transaction is evaluated, the model generates a score as a measure or representation of a likelihood of fraud. Ideally, the score should be proportional to the probability of fraud given that the data of current and past transactions is available. In other words:

Score˜Prob.(Fraud|current and previous transactions)

Risk tables are used to generate variables that are proxies to the above conditional probability. For example, a probability of fraud for a keyed transaction at a particular day-of-week may be estimated as:

$$Prob . ( Fraud \vert KEYED transaction \& DAY = n ) = \frac{Numberof KEYED Fraudtransactions during {n}^{th} day \text{-} of \text{-} week}{Numberof KEYED transactions during {n}^{th} day \text{-} of \text{-} week}$$

Whenever a similar transaction (i.e. keyed, and same day of week) is evaluated, Model retrieves the statistics information for that category from the risk table. Then the corresponding risk value is determined by the model and is used by the variables. Many variables may be defined based on the risk tables. These variables are then employed to build the model for fraud detection. They may be used directly as inputs to a neural network that executes the model, or to generate more complex variables.

In the above discussion of risk tables, there is an implicit assumption that the statistics of fraud and non-fraud transactions do not change over time. In fact, all of the historical transactions contributed equally to the risk tables. However, this assumption is invalid if fraud patterns or non-fraud customer spending patterns change. FIG. 1 shows the normalized risk (likelihood of fraud) for a specific country (USA) calculated over a seven day moving F window using a Canadian dataset. It is clear that the risk of transactions made in U.S. for Canadian cardholders changes significantly over time.

### SUMMARY

In general, this document discusses a system and method for detecting fraud, using fraud feedback and adaptive risk variables (ARV). ARVs capture temporal changes in fraud patterns and are used to adapt a fraud detection model to account for these temporal changes. One technique is based on defining shorter time-period risk variables. These variables are used in conjunction with the traditional (static) risk tables which capture the longer time-period risks. ARVs are defined with the purpose of capturing rapid changes in risk for different transaction categories.

In one aspect, a computer-implemented method for analyzing transactions for fraud is presented. The method includes augmenting a plurality of risk tables used by a fraud detection model with temporal change data related to risk variables associated with the plurality of risk tables. The method further includes executing the fraud detection model using the augmented plurality of risk tables to generate a score for transaction data representing a new transaction, the score representing a numerical probability of the existence of fraud based on the fraud detection model.

In another aspect, a computer-implemented method for analyzing transactions for fraud is presented. The method includes accumulating in a memory temporal change data related to risk variables associated with a plurality of risk tables used by a fraud detection model, and augmenting the plurality of risk tables with the temporal change data to update the fraud detection model. The method farther includes executing the updated fraud detection model on transaction data representing a new transaction to generate a score representing a numerical probability of fraud associated with the transaction data.

In yet another aspect, a computer-implemented system for analyzing transactions for fraud includes a processing module configured to execute a fraud detection model that generates a score for transaction data based on a plurality of risk tables, the score representing a numerical probability of the existence of fraud based on the fraud detection model. The system further includes a case generator that receives the score and based on additional inputs a fraud case tables, the fraud case table including data indicative of confirmed fraud and non-fraud for past transactions. The system further includes a database storing a list of recent authorized transactions and/or model variables, and a risk variable calculator adapted to calculate updated risk variables for the plurality of risk tables based on the database data and fraud case table data. The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a graph that illustrates normalized risk for financial transactions made in a foreign country.

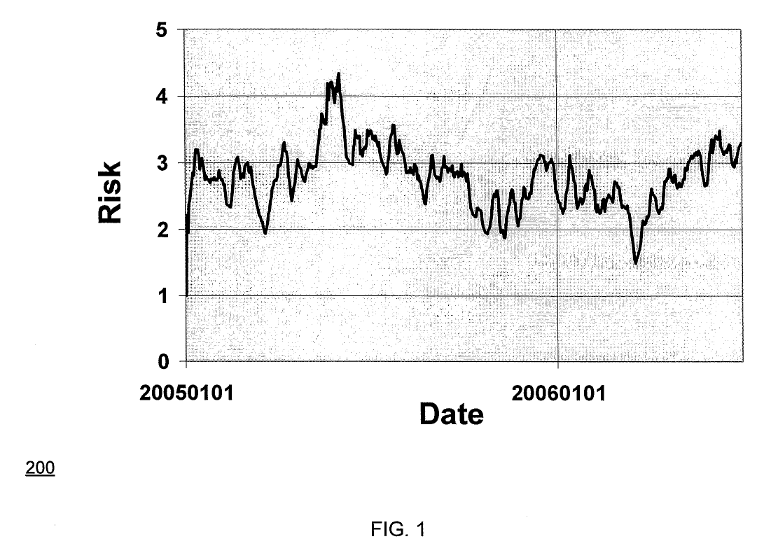

FIG. 2 is a block diagram of an adaptive risk variable system.

FIG. 3 is a flowchart of a fraud detection method using adaptive risk variables.

Like reference symbols in the various drawings indicate like elements.

### DETAILED DESCRIPTION

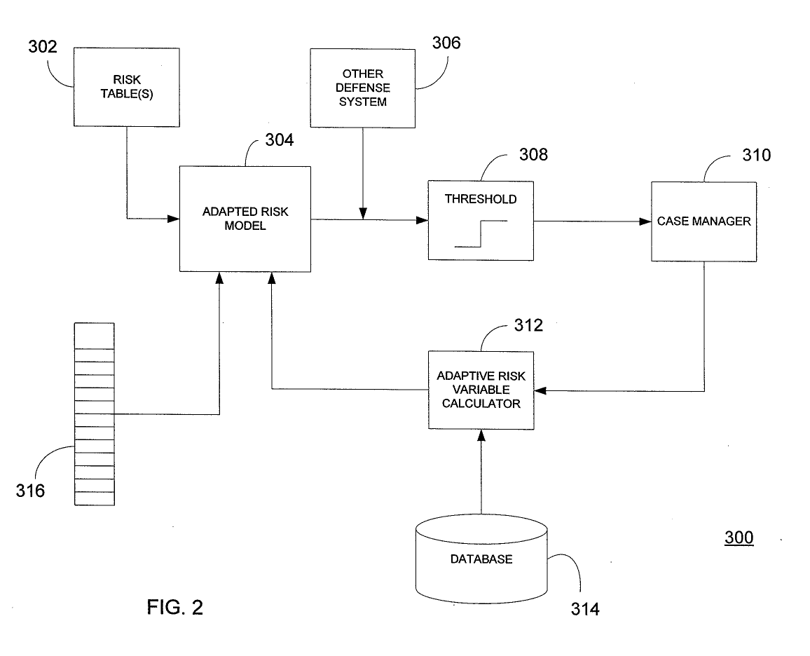

This document presents a fraud detection system and method using fraud feedback and adaptive risk variables (ARVs) to improve a fraud detection model. Unlike static risk tables, which are calculated based on historical data and are frozen afterwards, ARVs are updated on-line as new data arrives. As shown in FIG. 2, static risk tables 302 are loaded into a fraud detection model 304. The risk tables 302 are calculated off-line, and provide an indication of risk for various aspects related to a transaction. The model 304 evaluates each new transaction, as indicated by transaction data 316, to generate a score, which represents a likelihood of fraud for the transaction.

The model 304 can be optimized if properly accounting for temporal changes in the transaction data and the associated risks for each category 316, as will be discussed below. Generally, the model generates a score for every transaction. The score can be modified based on input from other fraud defense systems 306, which further enhance the score generated by the model 304. The augmented score is then passed through a threshold processor 308, i.e. compared against a predetermined threshold to indicate either a fraud, non-fraud, or undetermined case for the transaction, as represented by the transaction data 316. A case generator 310 determines for the system 300 the fraud, non-fraud and undetermined cases, to generate a fraud case table of all transactions occurring over a predetermined period. The case manager 310 can include, without limitation, additional computational algorithms or human input based on personal review of each fraud or non-fraud case, to determine whether such case really is valid or not.

Data from a list of recent transactions, i.e. transactions that have occurred over a set number of days, as well as additional variables selected by the model are stored in a database. The data from this database (covering recent transactions information and recent variables inside the model) are combined with the fraud case table to calculate one or more adaptive risk variables 312. The adaptive risk variables 312 represent not just fraud variables, but other risks or any other binary target of information. The adaptive risk variables 312 are fed back to the model 304, combined with the risk tables 302 being used by the model 304 to update the risk tables 302 or populate new risk tables, and thereby fine-tune the model 304 to better account for the temporal changes in the variables used by the model 304 to generate the score for the transaction.

In order to calculate an ARV, two sets of information are needed; 1) a list of recent transactions and/or model variables, and 2) confirmed (and/or suspect) fraud and non-fraud cases which could be identified at account level and/or transaction level. The list of recent transactions and/or model variables can be retrieved from the database 314, which stores the last number of days of authorization transactions and/or model variables. The confirmed (and/or suspect) fraud and non-fraud cases from the case manager 310 can be compiled by fraud analysts who verify and close the fraudulent accounts. This information, along with fraud cases that are detected through other means (e.g. fraud reports from external sources), is stored in fraud case tables. Once this information is collected, the ARVs can be calculated.

It is understood that the delay between fraud transactions and fraud account detection slows down the flow of information to the model 304. Nevertheless, this information is still the most current fraud information available for exploitation. It is important to note that current fraud detection profile variables which store account-based information may miss cross-accounts information. Therefore, ARV is a logical augmentation to profile variables, as described in U.S. Pat. Nos. 5,819,226 and 6,330,546, the contents of which are hereby incorporated by reference for all purposes.

ARVs can be defined for SIC, zip code, country and merchant ID categories. It is possible to define additional risk variables based on other transaction categories or a combination of two or more categories. For instance, the normalized F/NF ratio and $F/$NF can be calculated for each category over a seven-day moving window. As an example, the F/NF risk variable for SIC 5542 can be defined as:

$$\frac{F}{{NF}_{SIC = 5542}} = > \frac{{F}_{SIC = 5542} / {F}_{All SICs}}{{NF}_{SIC = 5542} / {NF}_{All SICs}}$$

where Fsic=5542 (NFsic=5542) is the number of fraud (non-fraud) transactions with SIC number 5542, and F_{AII SICs} (N_{FAII SICs}) is the total number of fraud (non-fraud) transactions. Based on this definition, the default risk value is 1. A risk value greater (or less) than 1 means that the relative risk for transactions with SIC=5542 is higher (or lower) than average. In one example, even though ARVs 312 are calculated based on the last seven days of transactions and fraud cases, the ARVs 312 provide a good indication of the likelihood of fraud for new or approaching transactions. The model 304 then uses the calculated ARVs 312 along with the traditional risk variables 302 to assess the “risk” of the future transactions.

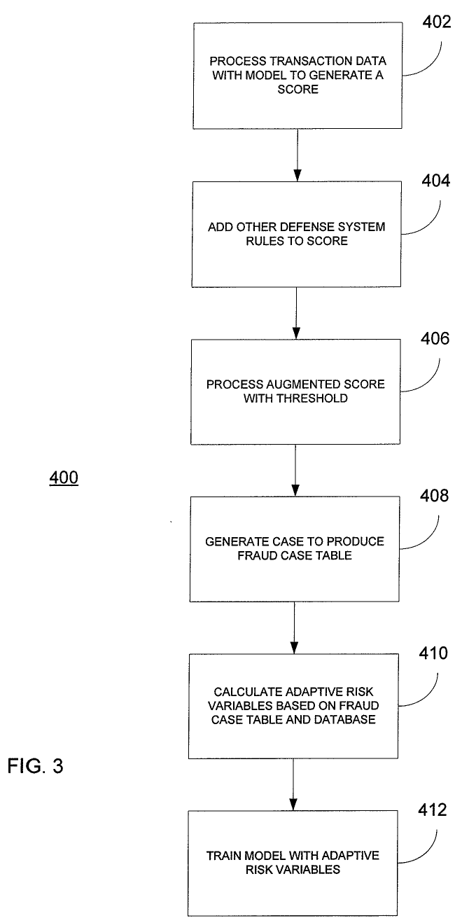

FIG. 3 is a flowchart of a fraud detection method 400 using ARVs. At 402, transaction data is processed by a model, utilizing one or more risk tables, to generate a score. Additionally, the model will save the transaction information and/or model variables in the database. At 404, input from other defense systems (e.g. user defined rules) is used to modify the score, which is then compared against a threshold at 406 to determine whether the score indicates fraud, non-fraud or unknown for the transaction. At 408, a fraud case table is generated with the new information, to indicate fraud, non-fraud and unknown statuses for the last set of transactions. At 410, adaptive risk variables are calculated based on the fraud case tables and data from the database (i.e. a table of a past number of authorized transactions and/or model variables). The adaptive risk variables are used by the model at 412 to augment the score to account for the temporal changes as represented by the adaptive risk variables.

Synthesized fraud feedback records may be used to “train” the model before implementation. This would help the model to “learn” what it supposed to do with the incoming feedback. It helps the model better utilize the ARVs in score generation.

The above description of an ARV is only one example of many possibilities. More complex risk variables can be defined using the available recent fraud and non-fraud transactions; such as “distance from mean fraud”, “dollar amount-mean fraud dollar amount”, etc. In addition, once ARVs are calculated, additional derived variables may be defined based on them.

ARVs enable the model to use the most recent information available. In conventional models with static risk tables, recent changes in spending (non-fraud) pattern or fraud pattern are not taken into the account by the model. ARV captures this information in a form that can be used by the model. In other words, ARV enables the model to “learn” from new information. Static risk tables also tend to average out rapid changes in risks. ARV focuses on short-term variation in risk, and makes it available to the model. Since ARV uses the new information, the performance of the model is preserved over a longer period. Therefore, ARV extends the lifetime of the models beyond the traditional models.

In consortium models, ARVs become client specific and are therefore updated based only on each client's recent transactions and fraud information. The client-centric approach of updating ARV adds a customization to consortium models. This is especially important since fraud patterns may vary from client to client.

Some or all of the functional operations described in this specification, such as the fraud detection model, can be implemented in digital electronic circuitry, or in computer software, firmware, or hardware, including the structures disclosed in this specification and their structural equivalents, or in combinations of them. Systems and methods disclosed herein can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the systems and methods disclosed herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and methods disclosed herein can be implemented in a computing system that includes a back end component, e.g., as a data server, or that includes a middleware component, e.g., an application server, or that includes a front end component, e.g., a client computer having a graphical user interface or a Web browser through b a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A computer-implemented method for analyzing transactions for fraud, the method comprising:
augmenting a plurality of risk tables used by a fraud detection model with temporal change data related to risk variables associated with the plurality of risk tables; and
executing the fraud detection model using the augmented plurality of risk tables to generate a score for transaction data representing a new transaction, the score representing a numerical probability of the existence of fraud based on the fraud detection model.

2. The method in accordance with claim 1, wherein the temporal change data includes data indicative of confirmed fraud and non-fraud for past transactions based on the fraud model.

3. The method in accordance with claim 2, wherein the temporal change data includes data from a database representing a list of recent authorized transactions and/or recent model variables.

4. The method in accordance with claim 1, wherein the risk variables are used during training of the model using incoming information.

5. The method in accordance with claim 1, wherein the risk variables includes merchant-related variables and geographic-related variables.

6. The method in accordance with claim 5, wherein the merchant-related variables includes a merchant ID and a merchandise category code.

7. The method in accordance with claim 1, wherein the temporal change data includes data accumulated over a predetermined period of time.

8. The method in accordance with claim 7, wherein the predetermined period of time ranges from days to months.

9. A computer-implemented method for analyzing transactions for fraud, the method comprising:
accumulating in a memory temporal change data related to risk variables associated with a plurality of risk tables used by a fraud detection model;
augmenting the plurality of risk tables with the temporal change data to update the fraud detection model; and
executing the updated fraud detection model on transaction data representing a new transaction to generate a score representing a numerical probability of fraud associated with the transaction data.

10. The method in accordance with claim 9, wherein the temporal change data includes data from a database representing a list of recent authorized transactions and/or model variables and stored in a first memory.

11. The method in accordance with claim 9, wherein the temporal change data is synthesized and is used to train the model.

12. The method in accordance with claim 9, wherein the temporal change data includes data indicative of confirmed fraud and non-fraud for past transactions based on the fraud model and stored in a second memory.

13. The method in accordance with claim 9, wherein the risk variables includes merchant-related variables and geographic-related variables.

14. The method in accordance with claim 13, wherein the merchant-related variables includes a merchant ID and a merchandise category code.

15. The method in accordance with claim 9, wherein the temporal change data is accumulated in the memory over a predetermined period of time.

16. The method in accordance with claim 15, wherein the predetermined period of time ranges from days to months.

17. A computer-implemented system for analyzing transactions for fraud, the method comprising:
a processing module configured to execute a fraud detection model that generates a score for transaction data based on a plurality of risk tables, the score representing a numerical probability of the existence of fraud based on the fraud detection model;
a case generator that receives the score and based on additional inputs a fraud case table, the fraud case table including data indicative of confirmed fraud and non-fraud for past transactions;
a database storing a list of recent authorized transactions and/or model variables; and
a risk variable calculator adapted to calculate updated risk variables for the plurality of risk tables based on the database data and fraud case table data.

18. The system in accordance with claim 17, further comprising a feedback connection from the risk variable calculator to the fraud detection model.

19. The system in accordance with claim 17, wherein the risk variables includes merchant-related variables and geographic-related variables.

20. The system in accordance with claim 17, wherein the merchant-related variables includes a merchant ID and a merchandise category code.

21. The system in accordance with claim 17, wherein the rolling authorization table data and the fraud case table data is accumulated in a memory over a predetermined period of time.

22. The system in accordance with claim 21, wherein the predetermined period of time ranges from days to months.
